(19) United States
(12) Patent Application Publication
(10) Pub. No.: US 2010/0049599 A1
(43) Pub. Date: Feb. 25, 2010

(54) FILTERING MOBILE MARKETING OFFERS

(75) Inventors: Sarah Owen, Denver, CO (US); Virginia G. Sayor, Larkspur, CO (US); Matt Withey, Highlands Ranch, CO (US); Todd R. Nuzum, Omaha, NE (US); Barbara C. Gaines, Omaha, NE (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corporation, Greenwood Village, CO (US)

(21) Appl. No.: 12/194,724

(22) Filed: Aug. 20, 2008

(51) Int. Cl. G06Q 30/00; G06Q 90/00

(52) U.S. Cl. 705/14.4

(57) ABSTRACT

Methods, systems, and machine-readable media are disclosed for filtering marketing messages sent to a mobile device. According to one embodiment, a method for filtering marketing messages sent to a mobile device can comprise receiving preference information from a user of the mobile device, the preference information indicating marketing offers the user considers to be relevant and generating one or more rules based on the preference information, the one or more rules defining conditions for marketing offers to be sent to the mobile device. The method can further comprise receiving marketing information related to at least one marketing offer, applying the one or more rules to the marketing information, and sending the marketing offer to the mobile device based on applying the one or more rules to the marketing information.

### BACKGROUND OF THE INVENTION

Embodiments of the present invention generally relate to mobile commerce. More specifically, embodiments of the present invention relate to methods and systems for filtering marketing messages sent to a mobile device.

Today, merchants and service providers accept many forms of payment. Many merchants will accept cash, credit cards, debit cards, stored-value cards, checks, and promotional items such as coupons. Additionally, various forms of wireless or contactless devices have been introduced for use in various types of transactions. For example, contactless transaction initiation is often performed with a “smart” card or other device such as a key fob or a mobile device such as a cell phone or Personal Digital Assistant (PDA) containing a memory and a processor. Such a card or device typically also includes Radio-Frequency IDentification (“RFID”) or Near-Field Communications (NFC) components for contactless communication with a Point-Of-Sale (POS) device. The information stored in the memory of the device and communicated via the RFID or NFC components to the POS device is generally similar or identical to the information recorded on the magnetic stripe of a card, i.e., account number etc. Thus, in some cases, such devices may be utilized instead of more conventional cards.

Various types of marketing offers, such as coupons, discount offers, etc. can be stored on the contactless device and can also be used in the transaction. For example, a marketing offer such as a coupon can be stored on a mobile device such as a cell phone or PDA by various means for use in a contactless transaction. When the coupon is redeemed, information related to the coupon can be displayed on the device and presented to the merchant at a POS. For example, the mobile device can display a bar code representing the coupon that can be scanned at the POS. In other cases, information related to the coupon can be transmitted to the POS device of the merchant via NFC communications when the consumer taps or passes the mobile device by the NFC reader of the POS device. The merchant is then responsible for communicating information about the redemption of the coupon to an entity tracking the coupon. For example, the merchant sends a message to the provider of the coupon, a provider of wireless services for the consumer's device, or another entity to record redemption of the coupon. Therefore, coupons and other marketing offers stored in and used with the mobile device can replace and eliminate the need for paper coupons, advertisements, offers, etc.

However, as the use of such marketing offers becomes more commonplace, there is an increasing risk of the offers becoming unmanageable. If the consumer is inundated with marketing offers that cannot be controlled, managed, organized, etc., the marketing offers can become less relevant to the user and are less likely to be used. In some cases, if the user cannot control the marketing offers sent to the user's mobile device in a way to provide only offers that may be relevant or useful to that user and manage or organize them in a way that makes them easy to use, the user may simply ignore all marketing offers or, if able, elect to not receive such offers at all. Hence, there is a need in the art for improved methods and systems for filtering marketing messages sent to a mobile device.

### BRIEF SUMMARY OF THE INVENTION

Methods, systems, and machine-readable media are disclosed for filtering marketing messages sent to a mobile device. According to one embodiment, a method for filtering marketing messages sent to a mobile device can comprise receiving preference information from a user of the mobile device, the preference information indicating marketing offers the user considers to be relevant and generating one or more rules based on the preference information, the one or more rules defining conditions for marketing offers to be sent to the mobile device. The method can further comprise receiving marketing information related to at least one marketing offer, applying the one or more rules to the marketing information, and sending the marketing offer to the mobile device based on applying the one or more rules to the marketing information. In some cases, the method can also include generating the marketing offer based on the marketing information. For example, the marketing offer can comprise a Short Message Service (SMS) message, a Multimedia Message Service (MMS) message, an email message, or other format message. In some cases, receiving the preference information from the user of the mobile device can comprise receiving the preference information via a web page. Additionally or alternatively, receiving the marketing information can comprise receiving the marketing information via a web page.

Applying the one or more rules to the marketing information can comprise, for example, determining whether the marketing information contains one or more keywords. In such cases, sending the marketing offer to the mobile device based on applying the one or more rules to the marketing information can comprise sending the marketing information to the mobile device in response to determining the marketing information contains the one or more keywords. Additionally or alternatively, applying the one or more rules to the marketing information can comprise determining whether the marketing information relates to a current location of the user of the mobile device. In such cases, sending the marketing offer to the mobile device based on applying the one or more rules to the marketing information can comprise sending the marketing information to the mobile device in response to determining the marketing information relates to the current location of the user of the mobile device.

In some cases, a user indication related to the sent marketing offer can be received and the one or more rules can be updated based on the received user indication. For example, the user preferences can be updated based on the received user indication and the one or more rules can be updated based on the updated user preferences. Additionally or alternatively, an indication of redemption of the marketing offer can be received and the one or more rules can be updated based on the received indication of redemption of the marketing offer. For example, history information related to redemption of past marketing offers by the user can be updated based on the received indication of redemption of the marketing offer and the one or more rules can be updated based on the updated history information.

According to another embodiment, a system can comprise a communication network, a mobile device communicatively coupled with the communication network, and a host system communicatively coupled with the communication network. The host system can be adapted to receive preference information from a user of the mobile device, the preference information indicating marketing offers the user considers to be relevant. The host system can generate one or more rules based on the preference information, the one or more rules defining conditions for marketing offers to be sent to the mobile device. The host system can be further adapted to receive marketing information related to at least one marketing offer, apply the one or more rules to the marketing information, and send the marketing offer to the mobile device based on applying the one or more rules to the marketing information. In some cases, the host system can also be adapted to generate the marketing offer based on the marketing information. For example, the marketing offer can comprise a Short Message Service (SMS) message, a Multimedia Message Service (MMS) message, an email message, or other format message. In some cases, the host system can be further adapted to provide a web page and receive the preference information from the user of the mobile device via the web page. Additionally or alternatively, the host system can be adapted to receive the marketing information via a web page.

Applying the one or more rules to the marketing information can comprise determining whether the marketing information contains one or more keywords. In such cases, sending the marketing offer to the mobile device based on applying the one or more rules to the marketing information can comprise sending the marketing information to the mobile device in response to determining the marketing information contains the one or more keywords. Additionally or alternatively, applying the one or more rules to the marketing information can comprise determining whether the marketing information relates to a current location of the user of the mobile device. In such cases, sending the marketing offer to the mobile device based on applying the one or more rules to the marketing information can comprise sending the marketing information to the mobile device in response to determining the marketing information relates to the current location of the user of the mobile device.

The host system can be further adapted to receive a user indication related to the sent marketing offer and update the one or more rules based on the received user indication. For example, the host system can be adapted update the user preferences based on the received user indication and update the one or more rules based on the updated user preferences. Additionally or alternatively, the host system can be adapted to receive an indication of redemption of the marketing offer and update the one or more rules based on the received indication of redemption of the marketing offer. For example, the host system can be adapted to update history information related to redemption of past marketing offers by the user and update the one or more rules based on the updated history information.

### BRIEF DESCRIPTION OF THE DRAWINGS

FIG. 1 is a block diagram illustrating an exemplary environment in which embodiments of the present invention may be implemented.

FIG. 2 is a block diagram illustrating an exemplary computer system upon which embodiments of the present invention may be implemented.

FIG. 3 is block diagram illustrating, at a high level, a system for processing transactions utilizing a mobile electronic device according to one embodiment of the present invention.

FIG. 4 is a block diagram illustrating elements of a system for filtering and/or managing marketing offers sent to a mobile device according to one embodiment of the present invention.

FIG. 5 is a flowchart illustrating a process for filtering marketing offers sent to a mobile device according to one embodiment of the present invention.

FIG. 6 is a flowchart illustrating a process for updating the filtering of marketing offers sent to a mobile device according to one embodiment of the present invention.

FIG. 7 is a flowchart illustrating a process for updating the filtering of marketing offers sent to a mobile device according to an alternative embodiment of the present invention.

FIG. 8 is a flowchart illustrating a process for managing marketing offers received by a mobile device according to one embodiment of the present invention.

FIG. 9 is a flowchart illustrating a process for managing marketing offers received by a mobile device according to an alternative embodiment of the present invention.

### DETAILED DESCRIPTION OF THE INVENTION

In the following description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form.

Embodiments of the invention provide methods and systems for processing various financial transactions initiated by or otherwise involving use of a contactless or mobile device as well as other information related to one or more financial accounts. In some such embodiments, the processes are executed by an entity on behalf of one or more client organizations. The description herein sometimes refers to “clients” and to “customers.” Reference to “clients” is intended to refer to persons, i.e. individuals, entities, or their agents, on whose behalf a set of information is managed. Reference to “customers” or “consumer” is intended to refer to persons, i.e. individuals, entities, or their agents, who are the subject of or related to that information. Thus, merely for purposes of illustration, in the case where the information comprises credit-card account records for a credit card issued to Mr. Jones by Bank A, Bank A corresponds to a client and Mr. Jones corresponds to a customer or consumer.

In describing embodiments of the invention, reference is sometimes made to other terms having specific intended meanings. For example, as used herein, the term “acquirer” refers to an entity that receives purchase transaction information from a merchant or other entity and, based on account identifier information, routes the transaction information over an electronic funds transfer network to an issuer of the account being used for payment.

The term “carrier” refers to a provider of a network and/or service for use by a mobile device. For example, a carrier can include, but is not limited to, a provider of a cellular or other wireless communications service for use by a mobile device. The terms “carrier” and “service provider” are used interchangeably herein and are intended to be synonymous.

A “marketing offer” refers to any coupon, rebate, discount, loyalty award, payment voucher, promotion, advertisement, or other such instrument that can be used by a consumer in a transaction. For example, a marketing offer can comprise a coupon which the consumer may use in a transaction to obtain a discount or other advantage when purchasing a specified product, from a specified merchant, at specified location, at a specified time, in combination with purchase of another product, and/or based on any of a variety of other possible conditions. Such a marketing offer may be used along with another payment vehicle or in place of another payment vehicle. For example, the marketing offer can be used to obtain a discount on the purchase price of a good or service wherein the difference between the full price and the discount, i.e., the discounted price, can be paid using a credit card, debit card, check, cash, or other payment vehicle. In other cases, the marketing offer may be a loyalty award, free offer, or other offer such that a difference need not be paid. That is, redemption of the marketing offer itself may provide payment in full for the transaction.

The term “mobile device” is used herein to refer to any small, likely handheld, electronic device that can be used to initiate or otherwise participate in a financial transaction. For example, a mobile device can include, but is not limited to a cellular telephone, a Personal Digital Assistant (PDA), a smart card or other contactless device, etc. Exemplary devices that may be adapted for use as mobile devices in various embodiments of the present invention are described in co-pending and commonly assigned U.S. patent application Ser. No. 11/672,417 entitled “Contactless Electronic Wallet Payment Device” filed on Feb. 7, 2007; U.S. patent application Ser. No. 11/551,063 entitled “Presentation Instrument with Non-Financial Functionality” filed on Oct. 19, 2006; and U.S. Provisional Patent Application No. 60/833,022 entitled “Mobile Payment Device with Magnetic Stripe” filed on Jul. 24, 2006, each of which is incorporated herein by reference in its entirety for all purposes.

A “mobile wallet” refers to a software application that can reside on and/or be executed by a mobile device. According to one embodiment, the mobile wallet can be adapted to store marketing offer information and, in some cases, payment vehicle information. In some cases, the mobile wallet can allow storage of multiple marketing offers and can provide a user interface that can be used to select a specific marketing offer. Additionally, the mobile wallet can be adapted to provide security to deter fraudulent and unauthorized use of the marketing offers and/or payment vehicles. As used herein, the terms mobile device, handset, and contactless device are intended to be synonymous. A “Mobile Wallet” can also be referred to as a handset “container.”

“Near Field Communication” (NFC) refers to short range (20 cm or less) wireless technology used to facilitate communication between electronic devices in close proximity. For example, embodiments of the present invention provide for the use of NFC and/or other relatively short range communications between a mobile device and a POS device such as when a user of the mobile device scans or waves the mobile device in front of or near the POS device when paying for goods or services.

A “payment network” refers herein to an infrastructure that supports that exchange of data in implementing payment transactions. It is anticipated that the data exchange typically proceeds between merchants and financial institutions. Examples of existing commercial networks that are included within the definition of “payment network” include the STAR/MAC network, the NYCE® network, the VISA® network, and the MasterCard® network. Access to a network by a consumer can be achieved through entry of a secret code, such as a personal identification number (“PIN”), in combination with data extracted from the mobile device. In some embodiments, a signature of the consumer may be used in lieu of a secret code. In some instances, particularly in support of transactions having a low value, a consumer might be permitted access to the payment network with only information extracted from the mobile device, without the need to provide a PIN or signature.

The term “payment vehicle” is used herein to refer to a method of payment. For example, payment vehicles can include, but are not limited to credit, debit, stored-value, and other types of accounts. In some embodiments, a payment vehicle can include loyalty points or other value accumulated, for example, under a loyalty program.

A “point-of-sale device” or “POS device” refers herein to any physical device situated at a location where a consumer may provide payment in support of a transaction. Such physical locations are typically merchant locations, such as where the POS device is operated by a clerk or is available for self-operation by the consumers (such as a vending machine), but may also be in other locations. For instance, certain automatic teller machines “ATMs” may be equipped to support transactions for the sale of movie or sporting-event tickets even remote from the merchant location; other similar types of transactions that may be performed with a POS device at a location remote from the merchant will also be evident to those of skill in the art. In some cases, a personal computer equipped with the appropriate structure may be used as a POS device even when located on the consumer premises. Examples of POS devices thus include, without limitation, personal computers, cash registers, and any devices capable of reading a magnetic stripe, an RFID chip, NFC communications, or other information from a mobile device, contactless device, card, etc. Exemplary devices that may be adapted for use in various embodiments of the present invention are described in the following commonly assigned applications, the entire disclosures of which are incorporated herein by reference for all purposes: U.S. Provisional Patent Application No. 60/147,889, entitled “Integrated Point OF Sale Device,” filed Aug. 9, 1999 by Randy J. Templeton et al.; U.S. patent application Ser. No. 09/634,901, entitled “Point of Sale Payment System,” filed Aug. 9, 2000 by Randy J. Templeton et al.; U.S. patent application Ser. No. 10/116,689, entitled “Systems and Methods for Performing Transactions at a Point-of-Sale,” filed Apr. 3, 2002 by Earney Stoutenburg et al.; U.S. patent application Ser. No. 10/116,733, entitled “Systems and Methods for Deploying a Point-of-Sale System,” filed Apr. 3, 2002 by Earney Stoutenburg et al.; U.S. patent application Ser. No. 10/116,686, entitled “Systems and Methods for Utilizing A Point-of-Sale System,” filed Apr. 3, 2002 by Earney Stoutenburg et al.; and U.S. patent application Ser. No. 10/116,735, entitled “Systems and Methods for Configuring a Point-of-Sale System,” filed Apr. 3, 2002 by Earney Stoutenburg.

A “POS processing system” refers to a computational system used by merchants to control communications between POS devices and payment networks. Such systems may be run internally by merchants, may be run by merchant consortia, or may be outsourced to service providers in different embodiments. Some exemplary POS processing systems which may be adapted to operate with embodiments of the present invention are described in commonly assigned U.S. Pat. Nos. 6,886,742, 6,827,260 and 7,086,584, the complete disclosures of which are herein incorporated by reference.

The terms “real time” or “near real time” are used herein to refer to a process or action that occurs within a relatively short time. Importantly, the terms real time and near real time are not intended to imply an immediate or instantaneous results or action. Rather, the terms are used to refer to process or actions that can be performed relatively quickly such as within several seconds or minutes.

The term “subscriber” is used herein to refer to a consumer who has contracted with a carrier to utilized the carrier's wireless communications network. It should be noted that the term subscriber is used in reference to a consumer contracting with a carrier while the terms customer/consumer, as described above, is used in reference to a consumer contracting with a financial services or merchant organization. It should be understood that the “subscriber” and “consumer/customer” can be the same individual or “user.”

The term “user” refers to an entity, typically a person, that is associated with a particular mobile device. Typically, the user is the person that owns, uses, or leases the mobile device and/or controls the content and use of the payment vehicles maintained within the mobile wallet of the device.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It being understood that various changes may be made in the function and arrangement of elements without departing from the spirit and scope of the invention as set forth in the appended claims.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination corresponds to a return of the function to the calling function or the main function.

The term “machine-readable medium” includes, but is not limited to portable or fixed storage devices, optical storage devices, wireless channels and various other mediums capable of storing, containing or carrying instruction(s) and/or data. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

Furthermore, embodiments may be implemented by hardware, software, firmware, middleware, microcode, hardware description languages, or any combination thereof When implemented in software, firmware, middleware or microcode, the program code or code segments to perform the necessary tasks may be stored in a machine readable medium. A processor(s) may perform the necessary tasks.

Embodiments of the present invention provide methods, systems, and machine-readable media for filtering and/or managing marketing offers sent to a mobile device. Generally speaking, a mobile device such as a cell phone, PDA, MP3 player, or other device can be adapted to execute a mobile wallet application and possibly other applications that provide any of a number of mobile commerce functions. For example, the mobile wallet and other elements described herein can allow the user of the mobile device to use the device to make purchases, receive and maintain receipts or other records of transactions, look up account balances, transfer balances, etc. Furthermore, the mobile wallet application can be adapted to store or maintain one or more marketing offers. The marketing offers can be loaded onto or provisioned to the mobile device in various manners.

Marketing offers stored on or accessible by a mobile device can be accessed and used in financial transaction such as purchases through the mobile wallet. As will be described in detail below, marketing offers sent to a mobile device can be filtered to improve the relevance of the marketing offers to a user of the mobile device. Generally speaking, filtering marketing messages sent to a mobile device can comprise receiving preference information from a user of the mobile device, the preference information indicating marketing offers the user considers to be relevant and generating one or more rules based on the preference information, the one or more rules defining conditions for marketing offers to be sent to the mobile device. The method can further comprise receiving marketing information related to at least one marketing offer, applying the one or more rules to the marketing information, and sending the marketing offer to the mobile device based on applying the one or more rules to the marketing information.

Additionally or alternatively, marketing offers sent to the mobile device can be managed in a way to make them easier to for the user of the mobile device to organize and utilize the marketing offers. Generally speaking, managing marketing offers sent to a mobile device can comprise receiving a marketing offer at the mobile device, receiving at the mobile device an indication of how to store the marketing offer, and storing the marketing offer on the mobile device based on the received indication. Receiving the indication of how to store the marketing offer can comprise receiving the indication from the user of the mobile device. Additionally or alternatively, receiving the indication of how to store the marketing offer can comprise receiving the indication with the marketing offer. The indication of how to store the marketing offer can comprise an indication of a location for storing the marketing offer. The location can comprise a sub-folder of an inbox of the mobile device, a sub-container of a mobile wallet of the mobile device, or another location.

As will be seen, storage of the marketing offers on the mobile device can be based on one or more storage rules saved local to or remote from the mobile device. When the storage rule(s) are saved locally, a marketing offer can be received at the mobile device, the storage rule can be applied to the marketing offer, and the marketing offer can be stored on the mobile device based on applying the storage rule. When the storage rule(s) are saved remotely, marketing information related to the marketing offer can be received by a remote host which can apply the storage rule to the marketing information and sending the marketing offer to the mobile device. In such cases, the marketing offer can include an indication of how to store the marketing offer on the mobile device based on applying the storage rule. Additional details of various embodiments of the present invention will be described below with reference to the figures.

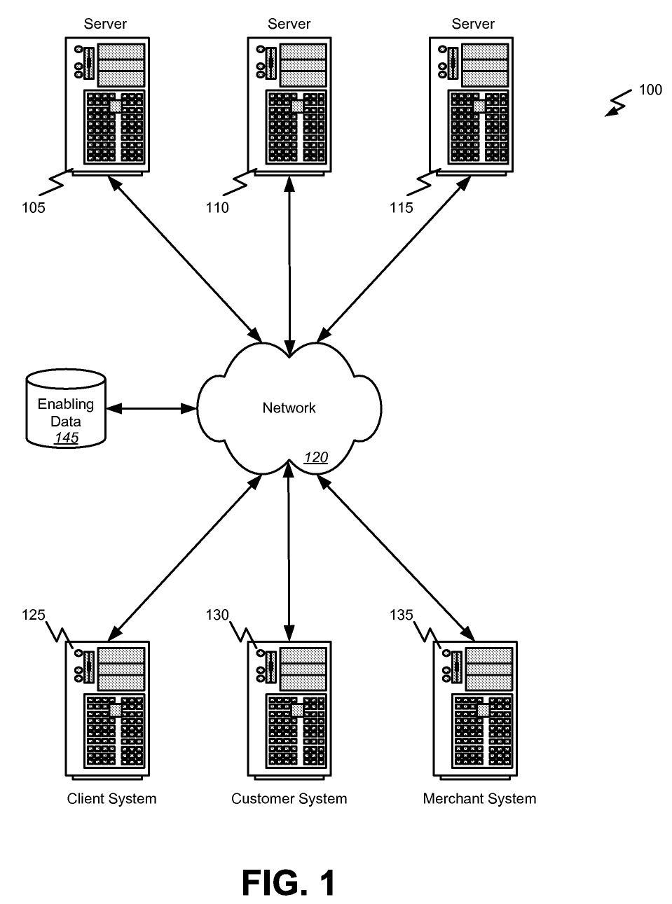

FIG. 1 is a block diagram illustrating an exemplary environment in which embodiments of the present invention may be implemented. In this example, the system can include one or more server computers 105, 110, 115 which can be general purpose computers and/or specialized server computers (including, merely by way of example, PC servers, UNIX servers, mid-range servers, mainframe computers rack-mounted servers, etc.). One or more of the servers (e.g. 130) may be dedicated to running applications, such as a business application, a web server, application server, etc. Such servers may be used to execute a plurality of processes related to financial transactions of one or more consumers on behalf of one or more client financial institutions. For example, one or more of the servers 105, 110, 115 may execute one or more processes for recording transactions on a credit card issued to the consumer by the financial institution. Other processes may provide for paying a merchant for the consumer's purchase, billing the consumer, etc The applications can also include any number of applications for controlling access to resources of the servers 105, 110, 115.

In some embodiments, the system 100 may also include a network 115. The network may can be any type of network familiar to those skilled in the art that can support data communications using any of a variety of commercially-available protocols, including without limitation TCP/IP, SNA, IPX, AppleTalk, and the like. Merely by way of example, the network 115 maybe a local area network (“LAN”), such as an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network (e.g., a network operating under any of the IEEE 802.11 suite of protocols, the Bluetooth protocol known in the art, and/or any other wireless protocol); and/or any combination of these and/or other networks such as GSM, GPRS, EDGE, UMTS, 3G, 2.5 G, CDMA, CDMA2000, WCDMA, EVDO etc.

The system 100 can include one or more user computers which may be used to operate a client, whether a dedicate application, web browser, etc. For example, the user computers can include a client system 125 operated by a client financial institution, a customer system 130 operated by a customer or consumer, a merchant system 135 operated by a merchant or vendor, etc. The user computers 125, 130, 135 can be general purpose personal computers (including, merely by way of example, personal computers and/or laptop computers running various versions of Microsoft Corp.'s Windows and/or Apple Corp.'s Macintosh operating systems) and/or workstation computers running any of a variety of commercially-available UNIX or UNIX-like operating systems (including without limitation, the variety of GNU/Linux operating systems). These user computers 125, 130, 135 may also have any of a variety of applications, including one or more development systems, database client and/or server applications, and web browser applications. Alternatively, the user computers 125, 130, 135 may be any other electronic device, such as a thin-client computer, Internet-enabled mobile telephone, and/or personal digital assistant, capable of communicating via a network (e.g., the network 115 described below) and/or displaying and navigating web pages or other types of electronic documents. Although the exemplary system 100 is shown with three user computers, any number of user computers may be supported.

The system 100 may also include one or more databases or repositories of enabling data 145. The database(s) of enabling data 145 may reside in a variety of locations. By way of example, a database 145 may reside on a storage medium local to (and/or resident in) one or more of the computers 105, 110, 115, 125, 130. Alternatively, it may be remote from any or all of the computers 105, 110, 115, 125, 130, and/or in communication (e.g. via the network 120) with one or more of these. In a particular set of embodiments, the database 145 may reside in a storage-area network (“SAN”) familiar to those skilled in the art. Similarly, any necessary files for performing the functions attributed to the computers 105, 110, 115, 125, 130 may be stored locally on the respective computer and/or remotely, as appropriate. In one set of embodiments, the database 145 may be a relational database that is adapted to store, update, and retrieve data in response to SQL-formatted commands. The repository of enabling data 145 can include a wide variety of information related to financial transactions related to the consumer and/or specified by different entities such as merchants, financial institutions, third-party advertisers, etc.

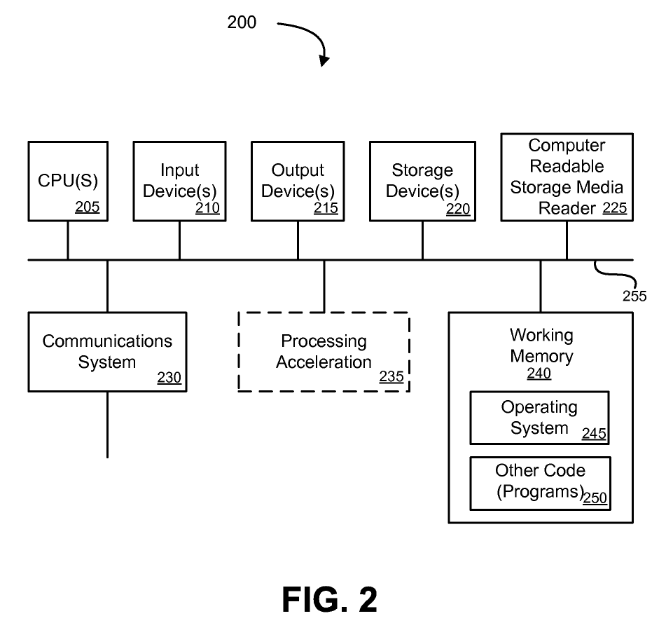

FIG. 2 is a block diagram illustrating an exemplary computer system upon which various elements of the exemplary environment illustrated in FIG. 1 may be implemented. The computer system 200 is shown comprising hardware elements that may be electrically coupled via a bus 255. The hardware elements may include one or more central processing units (CPUs) 205; one or more input devices 210 (e.g. a scan device, a mouse, a keyboard, etc.); and one or more output devices 215 (e.g., a display device, a printer, etc.). The computer system 200 may also include one or more storage device 220. By way of example, storage device(s) 220 may be disk drives, optical storage devices, solid-state storage device such as a random access memory (“RAM”) and/or a read-only memory (“ROM”), which can be programmable, flash-updateable and/or the like.

The computer system 200 may additionally include a computer-readable storage media reader 225; a communications system 230 (e.g., a modem, a network card (wireless or wired), an infra-red communication device, etc.); and working memory 240, which may include RAM and ROM devices as described above communicatively coupled with and readable by CPU(s) 205. In some embodiments, the computer system 200 may also include a processing acceleration unit 235, which can include a DSP, a special-purpose processor and/or the like.

The computer-readable storage media reader 225 can further be connected to a computer-readable storage medium, together (and, optionally, in combination with storage device(s) 220) comprehensively representing remote, local, fixed, and/or removable storage devices plus storage media for temporarily and/or more permanently containing computer-readable information. The communications system 230 may permit data to be exchanged with a network and/or any other computer or other type of device.

The computer system 200 may also comprise software elements, shown as being currently located within a working memory 240, including an operating system 245 and/or other code 250, such as an application program. The application programs may implement the methods of the invention as described herein. It should be appreciated that alternate embodiments of a computer system 200 may have numerous variations from that described above. For example, customized hardware might also be used and/or particular elements might be implemented in hardware, software (including portable software, such as applets), or both. Further, connection to other computing devices such as network input/output devices may be employed.

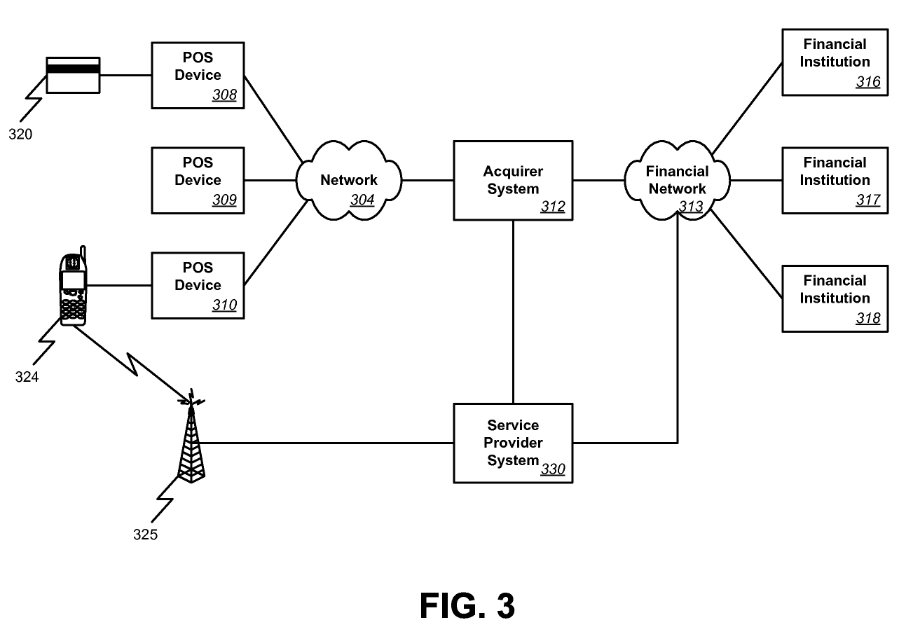

FIG. 3 is block diagram illustrating, at a high level, a system for processing transactions utilizing a mobile electronic device according to one embodiment of the present invention. Traditionally, a credit card may be issued to a customer by a financial institution such as a bank and typically displays a logo for an association that implements rules that govern aspects of use of the card. Account information is usually printed on the face of the card, specifying an account number and name of an authorized holder of the card; this information is also stored together with additional information on a magnetic stripe that is usually affixed to the back of the card. When the cardholder wishes to execute a transaction, such as a financial transaction for the purchase of goods and/or services, he presents the card 320 to a clerk at a merchant location, who swipes the card through a magnetic-stripe reader comprised by a point-of-sale device 308. Multiple point-of-sale devices 308-310 may have been provided at a variety of locations by an acquirer, who acts as an intermediary between merchants and the issuer financial institutions. As an intermediary, the acquirer coordinates transaction routing and performs a variety of backend processes.

The point-of-sale device 308 typically initiates a connection to an acquirer system 312 through a network 304 such as the Internet or another network as described above. A packet of information that includes information read from the magnetic stripe of the card 320, a merchant identifier, the date, and transaction amount are forwarded by the point-of-sale device 308 through the network 304 to the acquirer system 312. The acquirer system 312 may store some of the information and sends an authorization request, via financial network 313, to the issuing financial institution 316, which may be identified from a portion of the account number read from the magnetic stripe. The transaction is authorized or denied depending on such factors as the validity of the cardholder name, the validity of the card number, the level of available credit in comparison with the transaction amount, and the like. If authorized, an authorization code is routed back through the acquirer system 312, which captures additional information and forwards the authorization code back to the originating point-of-sale device 308 so that the transaction may be completed. Periodically, such as at the end of every day, the transactions are settled by the acquirer initiating funds transfers that fund merchant bank accounts with total transaction amounts that may have resulted from multiple transactions by multiple customers.

Other types of accounts may operate with similar structures, although the details for each type of account are different. For example, use of a debit account typically requires that the customer provide a personal identification number (“PIN”), which must be validated before any authorization for the transaction can be provided. Authorization usually depends on the current level of funds actually in the identified account rather than on a credit level, and funds transfer is usually executed substantially contemporaneously with providing the authorization rather than performing periodic settlement. Other types of accounts may use arrangements that have similar differences in their particulars.

According to one embodiment, a mobile device 324 may be used in addition to or instead of a card or other token representing an account. Here, the mobile device 324 is shown for exemplary purposes in the form of a cellular telephone. However, as noted above, the mobile device 324 may be any of a variety of different mobile devices including but not limited to a cell phone, PDA, MP3 player, etc. The mobile device 324 may communicate according to its normal wireless protocols with a service provider system 330 via an existing network of relay stations 325 In addition, the mobile device 324 may communicate wirelessly with point-of-sale devices 314 that have been equipped for wireless communications, such as through an NFC connection.

The mobile device 324 can be adapted to provide any of a number of mobile commerce functions related to one or more financial accounts such as credit accounts, debit accounts, demand deposit accounts, stored value accounts, etc. maintained by one or more financial institutions 316-318. The mobile device 324, for example via the mobile wallet application, may allow the user to review account balances, transfer balances, and/or select an account for a particular transaction such as a purchase or other payment. In the example of a purchase, upon selection of an account for use in the transaction, the user of the mobile device can scan or swipe the device 324 in front of or near the POS device 310 causing the selected account or other identifying information to be read from the mobile device 324 via the NFC connection.

The identifying information can indicate the account to be used in supporting transactions, for example, by including an indication of the financial institution 316 where that account is maintained, an account number, etc. According to one embodiment and as will be described in detail below, rather than storing account information on the mobile device to be read by the NFC reader, another unique identifier may be used. For example, a combination of the device serial number and user pin may be used to uniquely identify the user and/or device. The account to be used for the transaction can be indicated by information other than the account number and later correlated to the correct account number by the acquirer systems.

The point-of-sale device 308 typically initiates a connection to an acquirer system 312 through a network 304 such as the Internet or another network as described above. A packet of information that includes information read from the mobile device 324, a merchant identifier, the date, and transaction amount are forwarded by the point-of-sale device 310 through the network 304 to the acquirer system 312. The acquirer system 312 may store some of the information and send an authorization request, via financial network 313, to the issuing financial institution 318, which may be identified from a portion of the account number read from the mobile device 324. The transaction is authorized or denied depending on such factors as the validity of the account holder name, the validity of the account number, the level of available credit in comparison with the transaction amount, and the like. If authorized, an authorization code is routed back through the acquirer system 312, which captures additional information and forwards the authorization code back to the originating point-of-sale device 310 so that the transaction may be completed.

As will be seen, the mobile wallet and/or other applications or containers of the mobile device 324 may store or maintain one or more marketing offers. Marketing offers stored on or accessible by a mobile device 324 can be accessed through the mobile wallet or other application and used in financial transaction such as purchases. The marketing offers can be provided by a manufacturer, a merchant, a third party advertiser, or other entity and provisioned to the mobile device 324 in any of a variety of ways as known in the art. For example, the marketing offer can be provisioned to the mobile device Over-The-Air (OTA) via the service provider system 330 and network 325 in the form of an email, Short Message Service (SMS) message, Multimedia Messaging Service (MMS) message, or other format message. In other cases, marketing offers can be provisioned to the mobile device 324 via a wired or wireless connection of the mobile device to a network other than the service provider network 325. For example, if the wireless device 324 is equipped with an 802.11 connection and is coupled with a wireless LAN, the user of the mobile device 324 may be able to locate and download marketing offers via the Internet or other network. In yet another example, the mobile device 324 can obtain a marketing offer from another device. For example, the mobile device 324 can receive a marketing offer via a wired or wireless synchronization or other transfer operation from a personal computer (not shown here) that has obtained the marketing offer as a download from a website or in another manner known in the art. Similarly, the mobile device 324 can receive a marketing offer via a wired or wireless connection with another mobile device (not shown here) that has obtained the marketing offer in any manner described above or known in the art. According to one embodiment, provisioning of marketing offers to the mobile device can be performed, for example, according to the methods and systems described in U.S. application Ser. No. 11/830,420 filed on Jul. 30, 2007 and entitled “Provisioning of a Mobile Device for Mobile Commerce” which is herein incorporated by reference in its entirety for all purposes.

Regardless of exactly how the marketing offer is provisioned to the mobile device 324, the marketing offer can be stored in a mobile wallet or other container of the mobile device 324 and made available for use in a financial transaction in a manner similar to the payment vehicles described above. For example, the mobile device 324, via the mobile wallet or other application, may allow the user to review and/or select a marketing offer on the mobile device for use in a particular transaction such as a purchase. The user of the mobile device can scan or swipe the device 324 in front of or near the POS device 310 causing the selected marketing offer or information related to the selected marketing offer to be read from the mobile device 324 via the NFC connection. The merchant can then communicate information about the redemption of the coupon to the acquirer system 312, service provider system 330, a provider of the coupon, e.g., a third-party advertiser, or another entity tracking the coupon to record redemption and receive payment. According to one embodiment, redemption of the marketing offer can be performed, for example, according to the methods and system described in U.S. application Ser. No. 11/830,336 filed on Jul. 30, 2007 and entitled “Mobile Communication Systems and Methods for Redeeming and Reporting Coupons” which is herein incorporated by reference in its entirety for all purposes

As noted above, embodiments of the present invention provide methods, systems, and machine-readable media for filtering and/or managing marketing offers sent to a mobile device. As will be described in detail below, marketing offers sent to a mobile device can be filtered to improve the relevance of the marketing offers to a user of the mobile device. Generally speaking, filtering marketing messages sent to a mobile device can comprise receiving preference information from a user of the mobile device, the preference information indicating marketing offers the user considers to be relevant and generating one or more rules based on the preference information, the one or more rules defining conditions for marketing offers to be sent to the mobile device. The method can further comprise receiving marketing information related to at least one marketing offer, applying the one or more rules to the marketing information, and sending the marketing offer to the mobile device based on applying the one or more rules to the marketing information.

Additionally or alternatively, marketing offers sent to the mobile device can be managed in a way to make them easier to for the user of the mobile device to organize and utilize the marketing offers. Generally speaking, managing marketing offers sent to a mobile device can comprise receiving a marketing offer at the mobile device, receiving at the mobile device an indication of how to store the marketing offer, and storing the marketing offer on the mobile device based on the received indication. Receiving the indication of how to store the marketing offer can comprise receiving the indication from the user of the mobile device. Additionally or alternatively, receiving the indication of how to store the marketing offer can comprise receiving the indication with the marketing offer. The indication of how to store the marketing offer can comprise an indication of a location for storing the marketing offer. The location can comprise a sub-folder of an inbox of the mobile device, a sub-container of a mobile wallet of the mobile device, or another location.

As will be seen, storage of the marketing offers on the mobile device can be based on one or more storage rules saved local to or remote from the mobile device. When the storage rule(s) are saved locally, a marketing offer can be received at the mobile device, the storage rule can be applied to the marketing offer, and the marketing offer can be stored on the mobile device based on applying the storage rule. When the storage rule(s) are saved remotely, marketing information related to the marketing offer can be received by a remote host which can apply the storage rule to the marketing information and sending the marketing offer to the mobile device. In such cases, the marketing offer can include an indication of how to store the marketing offer on the mobile device based on applying the storage rule. It should be understood that the various embodiments of the present invention directed to filtering and managing marketing offers are can be independent of be independent of one another but are not mutually exclusive. That is, depending upon the exact implementation, embodiments related to filtering of marketing offers and embodiment related to managing marketing offers can be implemented separately or together.

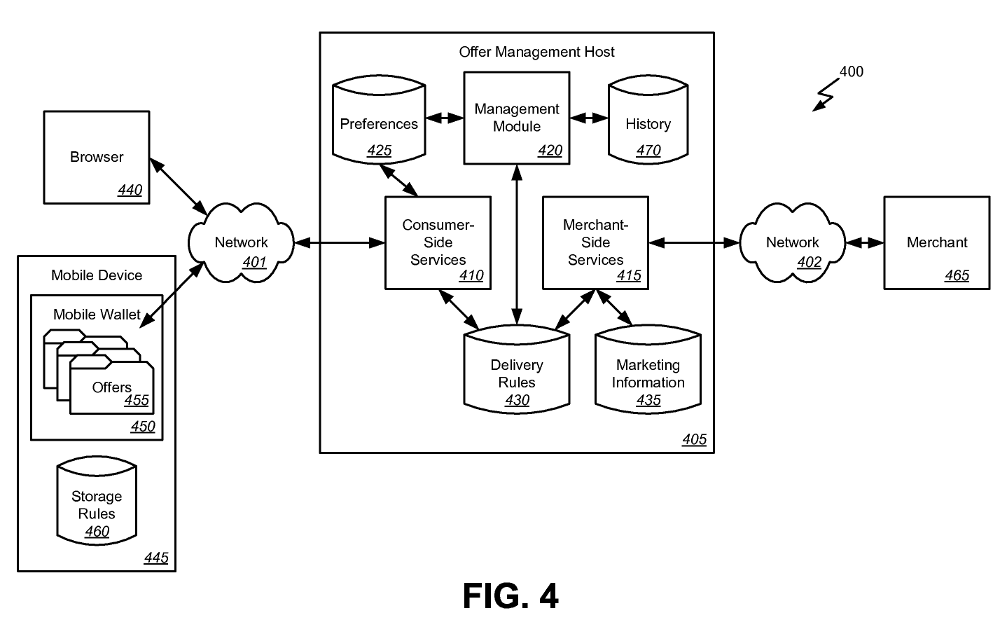

FIG. 4 is a block diagram illustrating elements of a system for filtering and/or managing marketing offers sent to a mobile device according to one embodiment of the present invention. As illustrated here, the system 400 can comprise a communication network 401 such as a wired or wireless LAN, WAN, Internet, or other communication network as described above. While illustrated here as a single element for clarity sake, it should be understood that communication network 401 can in fact comprise more than one network such as one or more wired LANs or WANs and one or more wireless LANs or WANs and different combinations thereof.

A mobile device 445 can be communicatively coupled with the communication network 401, for example via a cellular or other wireless communication. Generally speaking, the mobile device 445 can comprise a cell phone, PDA, MP3 player, or other device. In some cases, the mobile device 445 can be adapted to execute a mobile wallet 450 application and possibly other applications that provide any of a number of mobile commerce functions. For example, the mobile wallet 450 and other elements described herein can allow the user of the mobile device 445 to use the device 445 to make purchases, receive and maintain receipts or other records of transactions, look up account balances, transfer balances, etc. Furthermore, the mobile wallet 450 can be adapted to store or maintain one or more marketing offers 455. The marketing offers 455 can be loaded onto or provisioned to the mobile device in various manners as noted above.

The system 400 can also include a host system 405 communicatively coupled with the communication network 401. The host system 405 can comprise, for example, a system operated by an acquirer such as acquirer system 312 described above, a service provider such as service provider system 330 described above, a third party advertiser or other service, or other entity. The host system 405 can comprise, for example, a consumer-side services module 410, a merchant-side services module 415, a management module 420 and a number of repositories on information including but not limited to a repository of preference information, a repository of history information 470, a repository of delivery rules 430, and a repository of marketing offer information 435.

According to one embodiment, the host system 405 can be adapted to receive and store preference information 425 from a user of the mobile device 445. For example, the consumer-side services module 410 can comprise a web service providing a set of one or more web pages. In such a case, the host system 405 can receive preference information via consumer-side services module 410 from a browser 440 or other interface executing on a client device separate from the mobile device 445. In another example, the host system 405 can receive preference information via consumer-side services module 410 from a browser or other interface of the mobile device 445 itself. In either case, the preference information 425 can indicate marketing offers the user considers to be relevant. For example, the preference information 425 can comprise keywords or other information related to products, brands, services, merchants, vendors, service providers, types of offers, value of offers, time at or during which offers are valid/redeemable, location(s) at which offers are valid/redeemable, etc.

According to one embodiment, the host system 405, for example via consumer-side services module 410 and/or management module 420, can generate and save one or more delivery rules 430 based on the preference information 425. The one or more delivery rules 430 can define conditions for marketing offers to be sent to the mobile device. That is, the delivery rules 430 can comprise a logical combination of one or more conditions, i.e., related to the preference information and defining marketing offers which the user of the mobile device 445 considers to be relevant, and one or more associated actions, i.e., deliver or not deliver as well as how, when, and/or where to deliver in some cases. Additionally or alternatively, the host system 405 can be adapted to receive the delivery rules or rule definitions from the user of the mobile device 445 instead of or in addition to preference information 425. For example, the web page(s) or other interface provided by the consumer-side services module 410 can allow the user of the mobile device 445, either through the mobile device 445 or through a browser 440 or other interface of a client separate from the mobile device 445, to select or indicate the conditions and associated actions for the delivery rules 430.

The system 400 can also include a merchant system 465 or other advertiser communicatively coupled with a communication network 402 with which the host system 405 is also coupled. It should be understood that communication network 401 and communication network 402 can comprise the same or different/separate networks depending upon the exact implementation. The host system 405, for example via merchant-side services module 415, can be further adapted to receive and store marketing information 435 related to at least one marketing offer. For example, the merchant-side services module 415 can comprise a web service providing a set of one or more web pages. In such a case, the host system 405 can receive marketing information via merchant-side services module 415 from a browser or other interface of the merchant system 465.

The host system 405, for example, via merchant-side services module 415 and/or management module 420, can apply the one or more delivery rules 430 to the marketing information 435 and send the marketing offer to the mobile device 445 based on applying the one or more delivery rules 430 to the marketing information 435, i.e., based on whether the delivery rules 430 and the marketing information 435 indicate an offer the user of the mobile device 445 may find relevant/useful. In some cases, the host system 400 can also be adapted to generate the marketing offer based on the marketing information 435. For example, the marketing offer can comprise a Short Message Service (SMS) message, a Multimedia Message Service (MMS) message, an email message, or other format message. However, the marketing offers 455 can be loaded onto or provisioned to the mobile device 445 by the host system 405 in various manners as noted above.

As noted above, applying the one or more delivery rules 430 to the marketing information 435 can comprise determining whether the marketing information 435 contains one or more keywords, e.g., related to products, brands, services, merchants, vendors, service providers, types of offers, etc. In such cases, sending the marketing offer to the mobile device 445 based on applying the one or more delivery rules 430 to the marketing information 435 can comprise sending the marketing offer to the mobile device in response to determining the marketing information 435 contains the one or more keywords. Additionally or alternatively, applying the one or more delivery rules 430 to the marketing information 435 can comprise determining whether the marketing information 435 includes information indicating a value of an offer, time at or during which the offer is valid/redeemable, etc. In such cases, sending the marketing offer to the mobile device 445 based on applying the one or more delivery rules 430 to the marketing information 435 can comprise sending the marketing offer to the mobile device 445 in response to determining the marketing information 435 contains such information. Additionally or alternatively, applying the one or more delivery rules 430 to the marketing information 435 can comprise determining whether the marketing information 435 relates to a current location of the mobile device 445. That is, applying the one or more delivery rules 430 to the marketing information 435 can comprise determining whether the marketing information 435 indicates information indicating location(s) at which offers are valid/redeemable and whether the current location of the mobile device 445 corresponds thereto. The current location of the mobile device 445 can be determined in any of a number of different ways as known in the art including but not limited to location information from the service provider system based on one or more cell towers or sites with which the mobile device 445 is in range, radio signal triangulation, Global Positioning System (GPS) information provided by the mobile device 445 itself, as well as location information provided by third-party services such as the “My Location” service provided by Google™. Regardless of exactly how the current location of the mobile device 445 is determining, sending the marketing offer to the mobile device 445 based on applying the one or more delivery rules 430 to the marketing information 435 can comprise sending the marketing offer to the mobile device 445 in response to determining the marketing information 435 relates to the current location of the mobile device 445.

According to one embodiment, the host system 405 can be further adapted to receive, for example via consumer-side services 410, a user indication related to the sent marketing offer. For example, either through the mobile device 445 or a browser 440 or other interface of a client system separate from the mobile device 445, the user can indicate that the offer is relevant/interesting to the user and that the user wants to receive other such offers in the future, e.g., for the same product, from the same merchant, etc. Conversely, either through the mobile device 445 or a browser 440 or other interface of a client system separate from the mobile device 445, the user can indicate that the offer is not relevant/interesting to the user and that the user does not want to receive other such offers in the future. In either case, the host system 405, for example via consumer-side services module 410 and/or management module 420, can update the one or more delivery rules 430 based on the received user indication. For example, the host system 410 can be adapted to update the user preferences 425 based on the received user indication and update the one or more delivery rules 430 based on the updated user preferences 425. In other cases, the host system 405 may update the delivery rules 430 without updating user preferences 425. In either case, such updates may be performed in real-time or near real-time or periodically in a batch process.

Additionally or alternatively, the host system 405 can be adapted to receive, for example via merchant-side services module 415, an indication of redemption of the marketing offer and update the one or more delivery rules 430 based on the received indication of redemption of the marketing offer. For example, the host system 405, via the merchant-side services module 415 and/or management module 420, can be adapted to update history information 470 related to redemption of past marketing offers by the user and update the one or more delivery rules 430 based on the updated history information 470. That is, the history information 470 can indicate redemption of past offers by the user of the mobile device 445 and can be used to update the delivery rules 430 so that similar marketing offers, e.g., for the same or similar products, for the same or nearby location, at the same or similar times, etc., can be provided to the mobile device 445 in the future. Such updates may be performed in real-time or near real-time or periodically in a batch process.

According to another embodiment, the system 400 can provide for managing marketing offers 455 provided to the mobile device 445. For example, the mobile device 445 can be adapted to receive a marketing offer from the host system 405 via the communication network 401, receive an indication of how to store the marketing offer, and store the marketing offer based on the received indication. Receiving the indication of how to store the marketing offer can comprise receiving the indication from the user of the mobile device 445 through a user interface of the mobile device 445. The indication of how to store the marketing offer can comprise an indication of a location for storing the marketing offer such as a sub-folder of an inbox of the mobile device, a sub-container 455 of a mobile wallet 450 of the mobile device 445, or another location. Additionally or alternatively, receiving the indication of how to store the marketing offer can comprise receiving the indication from the host system 405. That is, instead of or in addition to the user of the mobile device 445 indicating a location for storing the marketing offer, the host system 405 can determine and indicate a location for storing the marketing offer. Such an indication can be provided to the mobile device as part of or separate from the marketing offer.

In some cases, the mobile device 445 can be adapted to receive and store an indication of one or more storage rules 460, e.g., from the user through the user interface of the mobile device 445. The storage rules 460 can define how the marketing offer will be stored on the mobile device 445. In such cases, the mobile device 445 can be further adapted to receive a marketing offer, apply the storage rule 460 to the marketing offer, and store the marketing offer based on applying the storage rule.

Alternatively, as noted above, the host system 405 can be adapted to receive and store an indication of a storage rule, for example from the mobile device 445 or through a browser 440 or other interface of a client system separate from the mobile device 445. The storage rule can define how the marketing offer will be stored on the mobile device. In some cases, the storage rule can be defined or generated by the host system 405 based on user preferences 425 defined and stored as described above. The storage rules can then be saved by the host system, for example, as part of the delivery rules 430 or as a separate set of rules (not shown here). The host system 405, for example via the merchant-side services module 415, consumer-side services module 410, and/or management module 420, can be further adapted to receive marketing information related to the marketing offer, apply the storage rule to the marketing information, and send the marketing offer to the mobile device 445. In such cases, the marketing offer or message containing the marketing offer may include an indication of how to store the marketing offer on the mobile device based on the host system applying the storage rule. In other cases, the indication of how to store the marketing offer can be sent to the mobile device 445 from the host system 405 as part of a message separate from, but referencing, the marketing offer. In either case, the mobile device 445 can be adapted to store the marketing offer based on the received indication from the host system 405.

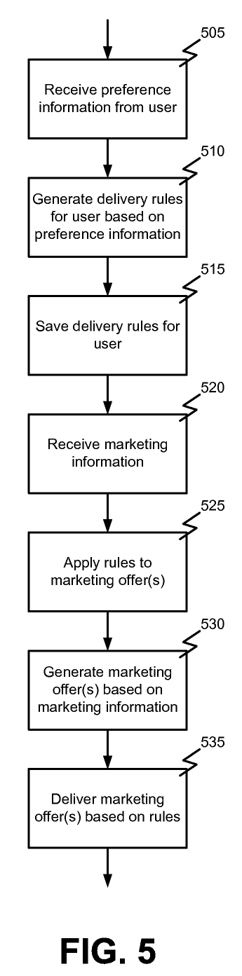

FIG. 5 is a flowchart illustrating a process for filtering marketing offers sent to a mobile device according to one embodiment of the present invention. In this example, processing begins with receiving 505 preference information from a user of the mobile device. In some cases, receiving the preference information from the user of the mobile device can comprise receiving the preference information via a web page. As described above, the preference information can indicate information related to or defining marketing offers the user considers to be relevant. One or more delivery rules can be generated 510 based on the preference information and saved 515. Also as described above, the one or more rules can define conditions for marketing offers to be sent to the mobile device.

At some later time, marketing information related to at least one marketing offer can be received 520 and the one or more delivery rules can be applied 525 to the marketing information. Receiving the marketing information can comprise receiving the marketing information via a web page. In some cases, the marketing offer can be generated 530 based on the marketing information. For example, the marketing offer can comprise a Short Message Service (SMS) message, a Multimedia Message Service (MMS) message, an email message, or other format message. The marketing offer can then be sent 535 to the mobile device based on applying 525 the one or more rules to the marketing information.

As noted above, applying 525 the one or more rules to the marketing information can comprise, for example, determining whether the marketing information contains one or more keywords. In such cases, sending 535 the marketing offer to the mobile device based on applying 525 the one or more rules to the marketing information can comprise sending 535 the marketing information to the mobile device in response to determining the marketing information contains the one or more keywords. Additionally or alternatively, applying 525 the one or more rules to the marketing information can comprise determining whether the marketing information relates to a current location of the user of the mobile device. In such cases, sending 535 the marketing offer to the mobile device based on applying 525 the one or more rules to the marketing information can comprise sending 535 the marketing information to the mobile device in response to determining the marketing information relates to the current location of the user of the mobile device.

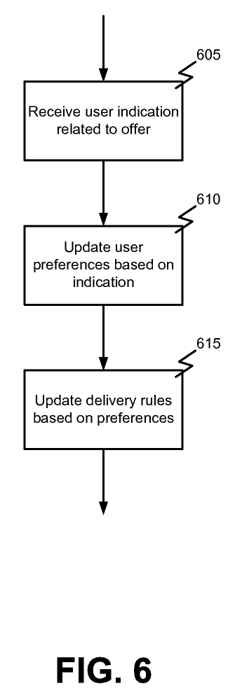

FIG. 6 is a flowchart illustrating a process for updating the filtering of marketing offers sent to a mobile device according to one embodiment of the present invention. As illustrated here, the process begins with receiving 605 a user indication related to the sent marketing offer. As noted above, the user indication can indicate that the offer is relevant/interesting to the user and that the user wants to receive other such offers in the future, e.g., for the same product, from the same merchant, etc. Conversely, the user indication can indicate that the offer is not relevant/interesting to the user and that the user does not want to receive other such offers in the future. In either cases, the user preferences can be updated 610 based on the received user indication and the one or more delivery rules can be updated 615 based on the updated user preferences. As noted above, the delivery rules may alternatively be updated 615 without updating 610 user preferences. In either case, such updates 610 and/or 615 may be performed in real-time or near real-time or periodically in a batch process.

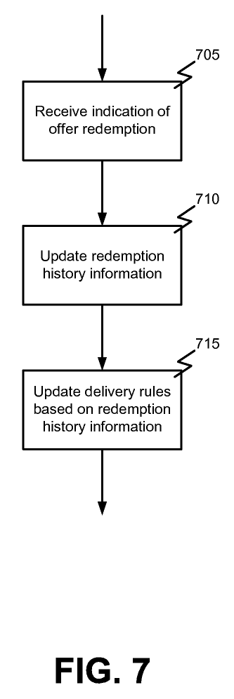

FIG. 7 is a flowchart illustrating a process for updating the filtering of marketing offers sent to a mobile device according to an alternative embodiment of the present invention. In this example, processing begins with receiving 705 an indication of redemption of the marketing offer. History information related to redemption of past marketing offers by the user can be updated 710 based on the received indication of redemption of the marketing offer. The one or more delivery rules can be updated 715 based on the received indication of redemption of the marketing offer. That is, the history information can indicate redemption of past offers by the user of the mobile device and can be used to update 715 the delivery rules so that similar marketing offers, e.g., for the same or similar products, for the same or nearby location, at the same or similar times, etc., can be provided to the mobile device in the future. Such updates 710 and 715 may be performed in real-time or near real-time or periodically in a batch process.

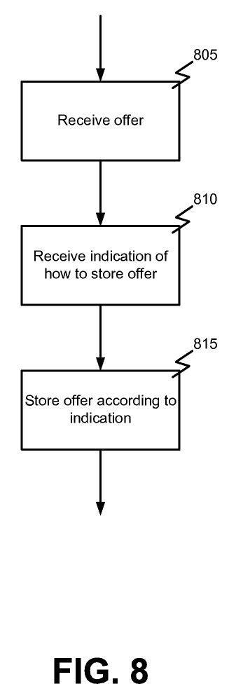

FIG. 8 is a flowchart illustrating a process for managing marketing offers received by a mobile device according to one embodiment of the present invention. In this example, processing begins with receiving 805 a marketing offer at the mobile device. An indication of how to store the marketing offer can also be received 810 at the mobile device. Receiving 810 the indication of how to store the marketing offer can comprise receiving the indication from the user of the mobile device. Additionally or alternatively, the indication can be received 810 either as part of or separate from the marketing offer or a message containing the marketing offer. The marketing offer can be stored 815 on the mobile device based on the received indication. The location can comprise a sub-folder of an inbox of the mobile device, a sub-container of a mobile wallet of the mobile device, or another location.

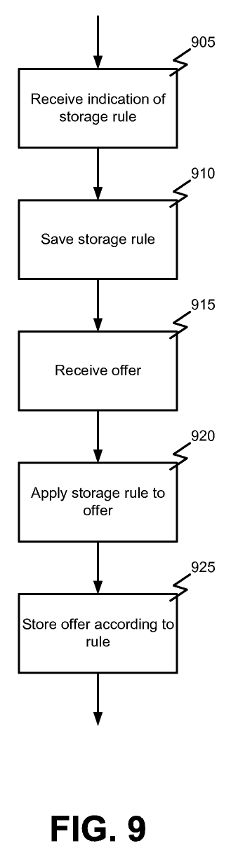

FIG. 9 is a flowchart illustrating a process for managing marketing offers received by a mobile device according to an alternative embodiment of the present invention. In this example, the process begins with receiving 905 and storing 910 an indication of a storage rule. The storage rule can define how the marketing offer will be stored on the mobile device. Saving 910 the storage rule can comprise saving the storage rule on the mobile device or remote from the mobile device. A marketing offer or marketing information can be received 915, either at the mobile device or by a host as described above. The storage rule can be applied 920 to the marketing offer or marketing information and the marketing offer can be stored 925 on the mobile device based on applying 920 the storage rule.

That is, saving 910 the storage rule can comprise saving 910 the storage rule on the mobile device. In such cases, the mobile device can receive 915 a marketing offer, apply 920 the storage rule to the marketing offer, and store 925 the marketing offer on the mobile device based on apply 920 the storage rule. Alternatively, saving 910 the storage rule can comprise saving 910 the storage rule remote from the mobile device, e.g., on a host. In such cases, the host can receive 915 marketing information related to the marketing offer, apply 920 the storage rule to the marketing information, and sending the marketing offer to the mobile device. In such a case, the marketing offer or message containing the marketing offer can include an indication of how to store the marketing offer on the mobile device based on the host applying the storage rule. Alternatively, the indication can be sent to the mobile device separate from the marketing offer or message containing the marketing offer. In either case, the mobile device can save 925 the marketing offer based on the indication from the host.

In the foregoing description, for the purposes of illustration, methods were described in a particular order. It should be appreciated that in alternate embodiments, the methods may be performed in a different order than that described. Additionally, the methods may contain additional or fewer steps than described above. It should also be appreciated that the methods described above may be performed by hardware components or may be embodied in sequences of machine-executable instructions, which may be used to cause a machine, such as a general-purpose or special-purpose processor or logic circuits programmed with the instructions, to perform the methods. These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

While illustrative and presently preferred embodiments of the invention have been described in detail herein, it is to be understood that the inventive concepts may be otherwise variously embodied and employed, and that the appended claims are intended to be construed to include such variations, except as limited by the prior art.

What is claimed is:

1. A method of filtering marketing offers sent to a mobile device, the method comprising:
receiving preference information from a user of the mobile device, the preference information indicating marketing offers the user considers to be relevant; and
generating one or more rules based on the preference information, the one or more rules defining conditions for marketing offers to be sent to the mobile device.

2. The method of claim 1, further comprising:
receiving marketing information related to at least one marketing offer;
applying the one or more rules to the marketing information; and
sending the marketing offer to the mobile device based on applying the one or more rules to the marketing information.

3. The method of claim 2, further comprising generating the marketing offer based on the marketing information.

4. The method of claim 3, wherein the marketing offer comprises a Short Message Service (SMS) message.

5. The method of claim 3, wherein the marketing offer comprises a Multimedia Message Service (MMS) message.

6. The method of claim 3, wherein the marketing offer comprises an email message.

7. The method of claim 1, wherein receiving the preference information from the user of the mobile device comprises receiving the preference information via a web page.

8. The method of claim 1, wherein receiving the marketing information comprises receiving the marketing information via a web page.

9. The method of claim 1, wherein applying the one or more rules to the marketing information comprises determining whether the marketing information contains one or more keywords.

10. The method of claim 9, wherein sending the marketing offer to the mobile device based on applying the one or more rules to the marketing information comprises sending the marketing information to the mobile device in response to determining the marketing information contains the one or more keywords.

11. The method of claim 1, wherein applying the one or more rules to the marketing information comprises determining whether the marketing information relates to a current location of the user of the mobile device.

12. The method of claim 11, wherein sending the marketing offer to the mobile device based on applying the one or more rules to the marketing information comprises sending the marketing information to the mobile device in response to determining the marketing information relates to the current location of the user of the mobile device.

13. The method of claim 1, further comprising:
receiving a user indication related to the sent marketing offer; and
updating the one or more rules based on the received user indication.

14. The method of claim 13, further comprising updating the user preferences based on the received user indication and wherein updating the one or more rules based on the received user indication comprises updating the one or more rules based on the updated user preferences.

15. The method of claim 1, further comprising:
receiving an indication of redemption of the marketing offer; and
updating the one or more rules based on the received indication of redemption of the marketing offer.

16. The method of claim 15, further comprising updating history information related to redemption of past marketing offers by the user and wherein updating the one or more rules based on the received indication of redemption comprises updating the one or more rules based on the updated history information.

17. A system comprising:
a communication network;
a mobile device communicatively coupled with the communication network; and
a host system communicatively coupled with the communication network, the host system adapted to receive preference information from a user of the mobile device, the preference information indicating marketing offers the user considers to be relevant and generate one or more rules based on the preference information, the one or more rules defining conditions for marketing offers to be sent to the mobile device.

18. The system of claim 17, wherein the host system is further adapted to receive marketing information related to at least one marketing offer, apply the one or more rules to the marketing information, and send the marketing offer to the mobile device based on applying the one or more rules to the marketing information.

19. The system of claim 18, wherein the host system is further adapted to generate the marketing offer based on the marketing information.

20. The system of claim 19, wherein the marketing offer comprises a Short Message Service (SMS) message.

21. The system of claim 19, wherein the marketing offer comprises a Multimedia Message Service (MMS) message.

22. The system of claim 19, wherein the marketing offer comprises an email message.

23. The system of claim 17, wherein the host system is further adapted to provide a web page and wherein receiving the preference information from the user of the mobile device comprises receiving the preference information via the web page.

24. The system of claim 17, wherein the host system is further adapted to provide a web page and wherein receiving the marketing information comprises receiving the marketing information via a web page.

25. The system of claim 17, wherein applying the one or more rules to the marketing information comprises determining whether the marketing information contains one or more keywords.

26. The system of claim 25, wherein sending the marketing offer to the mobile device based on applying the one or more rules to the marketing information comprises sending the marketing information to the mobile device in response to determining the marketing information contains the one or more keywords.

27. The system of claim 17, wherein applying the one or more rules to the marketing information comprises determining whether the marketing information relates to a current location of the user of the mobile device.

28. The system of claim 27, wherein sending the marketing offer to the mobile device based on applying the one or more rules to the marketing information comprises sending the marketing information to the mobile device in response to determining the marketing information relates to the current location of the user of the mobile device.

29. The system of claim 17, wherein the host system is further adapted to receive a user indication related to the sent marketing offer and update the one or more rules based on the received user indication.

30. The system of claim 29, wherein the host system is adapted update the user preferences based on the received user indication and update the one or more rules based on the updated user preferences.

31. The system of claim 17, wherein the host system is further adapted to receive an indication of redemption of the marketing offer and update the one or more rules based on the received indication of redemption of the marketing offer.

32. The system of claim 31, wherein the host system is adapted to update history information related to redemption of past marketing offers by the user and update the one or more rules based on the updated history information.
